(19) United States
(12) Patent Application Publication
(10) Pub. No.: US 2014/0105443 A1
(43) Pub. Date: Apr. 17, 2014

(54) REFLECTIVE CORDS

(71) Applicant: X-1 AUDIO INC., San Diego, CA (US)

(72) Inventors: Scott Tyler Kennerly, San Diego, CA (US); Christine Marie Petroff, San Diego, CA (US); Dana Christine Swanson, San Diego, CA (US); Thomas D Kampfer, San Diego, CA (US)

(73) Assignee: X-1 AUDIO INC., San Diego, CA (US)

(21) Appl. No.: 13/652,268

(22) Filed: Oct. 15, 2012

(51) Int. Cl. H04R 1/10

(52) U.S. Cl. CPC H04R 1/1033
USPC 381/384

(57) ABSTRACT

Disclosed herein are retroreflective audio cords. The audio cords can be coupled to an audio jack and headphones. The cords may include braided strands of a non-retroreflective material and retroreflective material. In use, the audio cords may be used to increase the visibility of the wearer. The audio cords may also be waterproof and/or configured to float.

### BACKGROUND

1. Field

The present disclosure relates generally to reflective cords, and more specifically, retroreflective audio cords for use in headphone wiring.

2. Description of the Related Art

In general, headphones or headsets include a communication link that transmits a signal from a signal source to a device configured to generate audible sounds. Often times, this communication link comprises an insulated audio wire having one end configured to be connected to a portable media player and at least one other end coupled to a small loudspeaker such as an earbud.

### SUMMARY

The devices, systems, and methods of the present disclosure have several features, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments,” one will understand how the features of this disclosure provide several advantages over other cords.

One aspect is an audio headset that may comprise a reflective cord that is configured to transmit an audio signal from a first end to a second end. The cord may include a connector that can be operatively coupled to one end of the cord. The connector may be configured to connect to a device that outputs an audio signal. Another end of the cord may be operatively coupled to at least one speaker. In some embodiments, the cord splits and the two ends of the split are each operatively coupled to a speaker. The reflective cord may include at least one retroreflective material. The retroreflective material may be disposed on a strand of flexible material. The flexible material may be braided with another strand of flexible material which may not comprise a retroreflective material. In some embodiments, the flexible material is nylon. In some embodiments, the retroreflective material is braided with a plurality of strands of flexible material that do not comprise retroreflective material. The retroreflective flexible material may be braided such that it runs over first two substantially parallel segments of flexible material that do not comprise retroreflective material and runs under second two substantially parallel segments of flexible material that do not comprise retroreflective material. The first and second substantially parallel segments of flexible material may be adjacent to each other.

Some embodiments can include braided strands of flexible retroreflective materials that surround a plastic insulator. The plastic insulator may surround a plurality of wires. The retroreflective material may Scotchlite™. The retroreflective material may include microspheres.

The headsets disclosed herein may be configured to be waterproof and/or configured to float in water. The headsets disclosed herein may include a controller and/or a microphone.

Another aspect is an audio headset that may comprise a cord encapsulated by braided strands of a non-retroreflective material and retroreflective material, an audio jack, at least one headphone.

### BRIEF DESCRIPTION OF THE DRAWINGS

These and other features, aspects, and advantages of the invention disclosed herein are described below with reference to the drawings of certain embodiments, which are intended to illustrate and not to limit the invention. Additionally, from figure to figure, the same reference numerals have been used to designate the same components of an illustrated embodiment. The following is a brief description of each of the drawings.

FIG. 1 is a perspective view of an audio headset device including a cord according to an embodiment of the present invention.

FIGS. 2-3 are side views of the cord of FIG. 1 taken about the line 2, 3.

FIG. 4 is cross-sectional view of the cord of FIG. 3 taken about the line 4-4.

### DETAILED DESCRIPTION OF CERTAIN EMBODIMENTS

The following description and examples illustrate preferred embodiments of the cord in the context of use with an exemplary headsets. More specifically, the embodiments disclosed herein relate to a cord that includes reflective and/or retroreflective materials such that the cord is configured to reflect light.

While the illustrated embodiment of the cord is shown in use with a headset that includes an audio connector, a controller, and two earbuds, there are several possible configurations that the disclosed cords can take to include the various aspects and features described herein. Thus, the illustrations of the cord in this particular context is not intended to limit the disclosed aspects and features to the specified embodiment or to usage only with the illustrated headset. For example, the disclosed embodiments can be used with a headset that includes a microphone and the audio connector and sound generating devices may be any suitable size and configuration known in the art. Those of skill in the art will recognize that the disclosed aspects and features are not limited to any particular embodiment of a cord, and systems or devices, which include one or more of the inventive aspects and features herein described, can be designed for use in a variety of implementations.

It will be understood by those of skill in the art in view of the present disclosure that the cords described herein can be used in connection with various devices including, but not limited to, portable audio players, mobile telephones, portable videogame devices, personal digital assistants, tablets, and other consumer electronic devices. The cords may also be configured transmit and receive signals other than or in addition to audio signals.

The cord described herein is especially adapted to reflect light. In some embodiments, the cord can reflect a significant amount of light even under low light conditions. In some embodiments, materials in the cord can reflect incoming light with minimal scattering. Thus, the cord can appear extremely bright from at least the perspective of the light source. In some embodiments, materials in the cord can reflect light omnidirectionally over a large angle of acceptance. The cords may also be sized to be longer than necessary such that there is ample slack in the cord between the audio jack and the headphones. This slack may allow for increased movement of the cord during use. In this way, the slack can result in increased movement of the cord when a user is walking or running. For example, the cords can increase the visibility of night time joggers using the cords with their audio devices. Car headlights, for instance, can illuminate the surfaces of the cord and the reflect light towards the car and its driver, thus increasing the conspicuity of the jogger as a safety measure. The additional movement of the cords can further increase the visibility of a user by drawing the attention of drivers. Accordingly, the various embodiments the present inventions thus provide a means to increase the visibility of a wearer of the cords in low light, for example at dusk or at night.

The cords may also be used with water resistant, waterproof, or SCUBA capable headsets. As used herein, “waterproof” means that the device referred to as “waterproof” is capable of being completely submerged under water for a substantial period of time without water penetrating a “waterproof” barrier. The substantial period of time may include 30 seconds, 1 minute, 1 hour, or greater than 1 hour. As used herein, “SCUBA capable” means able to withstand pressures experienced by a SCUBA diver, for example, pressures at underwater depths between about 10 and 300 feet. For example, features of the cords described herein can be incorporated into headsets described in U.S. Pat. No. 7,263,032, which is incorporated by reference in its entirety, or with other waterproof headsets, headphones, and/or earbuds known in the art. In some embodiments, the cords may be configured to float in water. For example, these cords can be used to increase the visibility of evening ocean surfers or swimmers using the cords with their audio devices.

Various aspects will now be described with reference to specific forms or embodiments selected for the purposes of illustration. It will be appreciated that the spirit and scope of the cords disclosed herein is not limited to the selected forms. Moreover, it is to be noted that the figures provided herein are not drawn to any particular proportion or scale, and that many variations can be made to the illustrated embodiments.

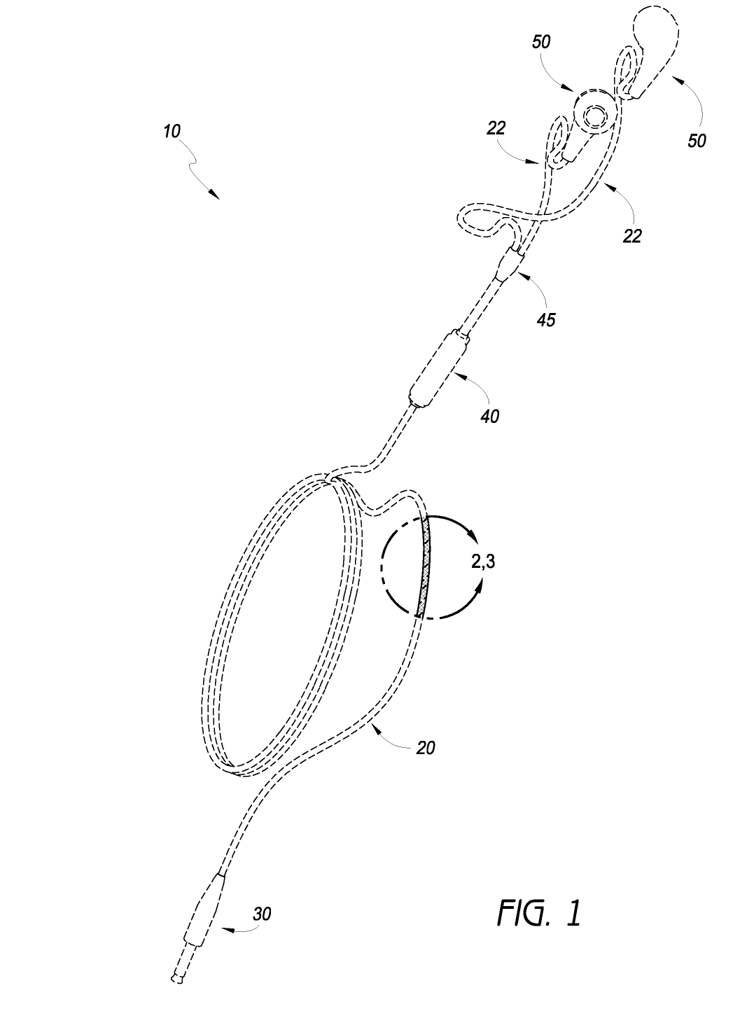

With reference to FIG. 1, the illustrated headset 10 includes a connector 30, coupled to a main cord 20, a controller 40, a splitter 45, and left and right cords 22 coupled respectively to left and right earbud speakers 50.

The connector 30 can be any suitable connector. For example, the connector 30 typically includes three contacts that can communicate with an electronic device when the connector 30 is coupled to said electronic device but, the connector 30 can include more or less contacts depending on the device that the connector 30 is configured to be used with.

The headset may or may not include a controller 40. The controller 40 can be configured to control the device that the headset 10 is coupled to with the connector 30. For example, the controller 40 can include one or more controls to allow a user to adjust for example the audio volume, advance, pause, or play a song, answer a phone, etc. The controller 40 may or may not include a microphone. The interface between the controller 40 and the cord may be sealed with glue or ultrasonic welding.

The main cord 20 splits into left and right cords 22 at splitter 45. The main cord 20 can be any suitable length. For example, in some embodiments the main cord 20 is about two to three feet in length. In other embodiments, the main cord 20 is about four to five feet in length. The left and right cords 22 can also be any suitable length. In some embodiments, the left and right cords 22 are about half a foot to one foot in length. The splitter 45 is generally made of hard plastic so as to prevent fraying or damage to the cord 20 at the split.

In some embodiments, the main cord 20 and the left and right cords 22 include sheathed copper wiring. The sheathed wiring can transmit audio signals and or other signals through the cord. The sheathed wiring can be surrounded or encapsulated by at least one reflective and/or retroreflective material. The reflective material may include microspheres or microlenses. The reflective material may be flexible. The reflective material may contain retroreflector elements or retroreflective lenses. The material can be a fabric and may include wide angle retroreflective lenses bonded to a durable backing. In some embodiments, the reflective and/or retroreflective material is Scotchlite™ available from 3M Corp. (St. Paul, Minn.). In some embodiments the reflective material is silver and reflects white light.

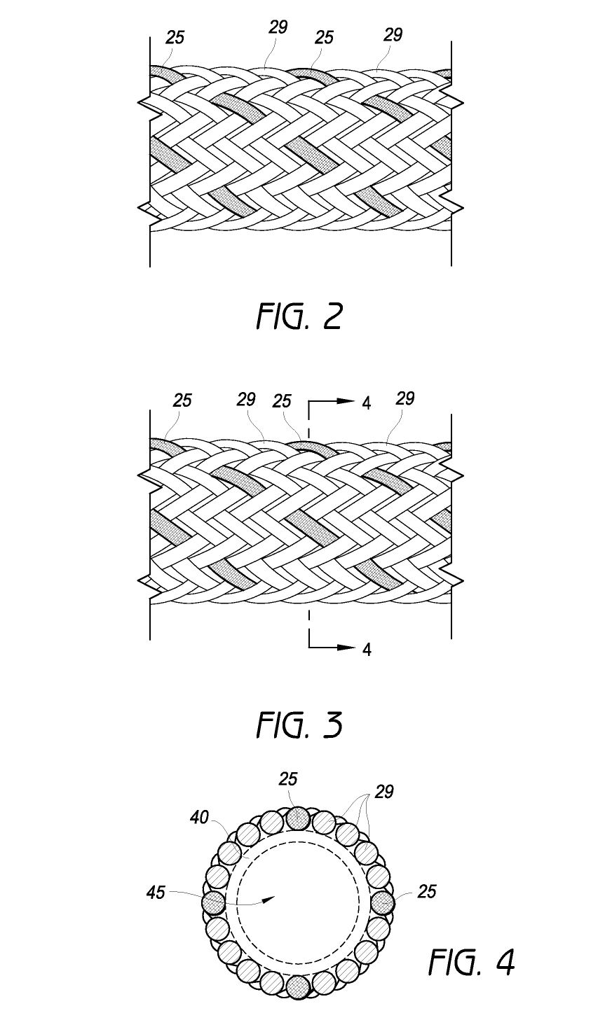

Turning to FIGS. 2-3, strands or thin sheets of reflective and/or retroreflective material 25 can be braided with strands of supporting material 29 that do not contain retroreflective material. The supporting material 29 can be nylon, or other flexible polymers such as PVC. Materials such as Scotchlite™ may tear or fray easily. Thus, weaving or braiding of the reflective and/or retroreflective material with supporting material that does not contain retroreflective material can result in a more durable outer layer. In other words, for example, the sheathed wiring may be wrapped with a braided matrix of supporting material and retroreflective material to form a more robust cord than surrounding the sheathed wiring with the retroreflective material alone.

FIG. 4 illustrates a cross-sectional view of the cord of FIG. 3 taken about the line 4-4. As shown, the braided cord includes four strands of reflective and/or retroreflective material 25 and sixteen strands of supporting material 29. However, the number of strands of reflective and/or retroreflective material 25 and number strands of supporting material 29 can vary depending on the application, required thickness, and desired reflective qualities of the cord. In addition, a variety of braiding patterns may be utilized. For example, as depicted in FIGS. 2-3, the strand of retroreflective material 25 runs over two substantially parallel strands of the supporting material 29 and runs under adjacent two substantially parallel strands of the supporting material 29. Any number of braiding permutations are possible (e.g., over 3-under 3; over 1-under 2; over 2-under 1; etc.). Similarly, the braiding of the supporting material 29 in regions where no retroreflective material 25 is present can have a variety of patterns.

The inside of the cord 45 can contain insulated wiring. An additional layer 40 of insulation or surrounding material can also be included. This additional layer 40 or sheath can be formed of a flexible plastic, rubber, or other suitable material. As such, the reflective covering can surround this additional layer 40. In some embodiments, low density material such as a foam core is also included inside of the cord 45 such the cord is configured to float in water.

Of course, it is to be understood that not necessarily all objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the features of the cords disclosed in the various embodiments can be switched between embodiments. In addition to the variations described herein, other known equivalents for each feature can be mixed and matched by one of ordinary skill in this art to construct reflective cords and techniques of use of such cords in accordance with principles of the present invention.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. An audio headset comprising:
a reflective cord configured to transmit an audio signal from a first end to a second end;
a connector operatively coupled to the first end and configured to connect to a device that outputs an audio signal; and
at least one speaker operatively coupled to the second end.

2. The headset of claim 1, wherein the reflective cord includes at least one retroreflective material.

3. The headset of claim 2, wherein the retroreflective material is disposed on a first strand of flexible material.

4. The headset of claim 3, wherein the first strand of flexible material is braided with a second strand of flexible material, wherein the second strand of flexible material does not comprise retroreflective material.

5. The headset of claim 4, wherein the second strand of flexible material is nylon.

6. The headset of claim 4, wherein the first strand of flexible material is braided with a plurality of strands of flexible material that do not comprise retroreflective material.

7. The headset of claim 4, wherein the first strand of flexible material is braided such that it runs over first two substantially parallel segments of flexible material that do not comprise retroreflective material and runs under second two substantially parallel segments of flexible material that do not comprise retroreflective material, wherein the first and second two substantially parallel segments of flexible material are adjacent to each other.

8. The headset of claim 4, wherein the braided strands surround a plastic insulator.

9. The headset of claim 8, wherein the plastic insulator surrounds a plurality of wires.

10. The headset of claim 2, wherein the retroreflective material is Scotchlite™.

11. The headset of claim 2, wherein the headset is waterproof

12. The headset of claim 2, wherein the headset is configured to float in water.

13. The headset of claim 2, further comprising a controller.

14. The headset of claim 2, further comprising a microphone.

15. An audio headset comprising:
a cord encapsulated by braided strands of a non-retroreflective material and retroreflective material;
an audio jack; and
at least one headphone.

16. The headset of claim 15, wherein the retroreflective material includes microspheres.
